(19) United States
(12) Patent Application Publication
(10) Pub. No.: US 2008/0246590 A1
(43) Pub. Date: Oct. 9, 2008

(54) Information Apparatus with Rfid Tag and Control Method Thereof

(75) Inventor: Kwang-Bum Lee, Gyeonggi-do (KR)

Correspondence Address: CANTOR COLBURN, LLP, 20 Church Street, 22nd Floor, Hartford, CT, 06103, US

(73) Assignee: U BRIDGE CO., LTD., Seoul (KR)

(21) Appl. No.: 12/088,305

(22) PCT Filed: Sep. 27, 2006
(86) PCT No.: PCT/KR2006/003855

§ 371 Date: Mar. 27, 2008

(30) Foreign Application Priority Data
Sep. 28, 2005 (KR) 10-2005-0090655

(51) Int. Cl. H04Q 5/22

(52) U.S. Cl. 340/10.51

(57) ABSTRACT

An information apparatus having an RFID tag and a control method thereof. The information apparatus includes the RFID tag part which comprises an RF receiver receiving an external RF signal, an RF transmitter transmitting an RF signal to outside, a logic part performing controlling and comparison, and a tag memory storing data; and a controller which stores a digital content provided from outside by directly accessing to the tag memory without passing through the RF receiver and the RF transmitter. Accordingly, the digital content stored to or reproduced at the information apparatus is easily transferred and stored to the personal device having the RFID reader and then used. Thus, the utilization of the digital content can be drastically enhanced.

### TECHNICAL FIELD

The present invention generally relates to an information apparatus with a radio frequency identification (RFID) tag and a control method thereof. More particularly, the present invention relates to an information apparatus with an RFID tag, which can provide digital contents to a personal device having an RFID reader through the RFID tag being low-priced and prevalently used, and a control method of the information apparatus.

### BACKGROUND ART

According to radio frequency identification (RFID) technology, we can write information relating to all processes including production, distribution, storage, and consumption to tags attached to products, read the information using an RFID reader via an antenna, and utilize the information with an information system in association with a satellite or a mobile radio communication network.

In general, the RFID tag of the RFID system is implemented as a single chip set. The RFID tag is divided to an active tag and a passive tag according to presence or absence of its power supply source, and to a low-frequency tag and a high-frequency tag according to the frequency band used by its RF process part.

A typical structure of the RFID tag includes a controller providing an operation function and a data input/output function, a memory storing RFID information, and an RF processor wirelessly communicating with an antenna. The active tag further includes a power supply source.

The controller of the RFID tag controls to input or output the RFID information stored to or from the memory according to an external signal fed from the RF processor and to communicate the input or output RFID information to the outside through the RF process part.

The memory of the RFID tag is a memory which stores the RFID information to be transmitted to the RFID reader according to the external signal received through the RF process part. The memory can store characters, numbers, symbols, and/or binary data depending on the application field of the RFID tag. The capacity of the commercial memories is various ranging 25 bits˜512 Kbytes.

The RF process part of the RFID tag serves to receive a signal from the RFID reader via the antenna, provide the received information to the controller, and transmit the RFID information extracted from the memory by the controller to the RFID reader. Frequency used by the RF processor of the commercial RFID tag is various, including 135 KHz, 13.56 MHz, 433 MHz, 860˜930 MHz, 2.45 GHz, and 5.8 GHz.

The RFID reader of the RFID system includes one or more RF modules which process the RFID information transmitted and received to and from the RFID tag via an antenna. In some cases, the RFID reader can have a program to provide a series of information processing functions for the RFID information.

If the RFID reader consists of merely the RFID modules, the RFID reader works in association with the information processing system to process the RFID information over the wired and wireless networks.

The conventional RFID system has been used to process and manage the information relating to all processes including the production, the distribution, the storage, and the consumption of the tangible products by attaching the tag to the tangible products. However, the conventional RFID system cannot provide the tag function for digital contents such as codes, characters, voice, sound, image, and digitally processed video, besides the tangible products.

In addition, the related art does not disclose any methods to store, modify, reuse, and distribute the digital content using the RFID system.

### DISCLOSURE OF INVENTION

### Technical Problem

The purpose of the present invention is to provide an information apparatus with an RFID tag, which can provide a user with digital content reproduced at the information apparatus or attribute information of the digital content through an RFID reader, and a control method of the information apparatus.

### Technical Solution

According to an aspect of the present invention, an information apparatus having an RFID tag includes the RFID tag part which comprises an RF receiver receiving an external RF signal, an RF transmitter transmitting an RF signal to outside, a logic part performing controlling and comparison, and a tag memory storing data, and a controller which stores a digital content provided from outside by directly accessing to the tag memory without passing through the RF receiver and the RF transmitter.

The information apparatus may further include a communication interface part which receives the digital content from outside; and a reproduction part which reproduces the digital content under control of the controller.

The controller may partition the digital content into a format including an identifier and sequentially overwrite to the tag memory when a quantity of the digital content exceeds a capacity of the tag memory.

The RFID tag part may include a plurality of RFID tags. When a quantity of the digital content exceeds a capacity of one tag memory, the controller may partition the digital content into a format including an identifier and write or overwrite to the memory of the RFID tags, respectively, in parallel.

The controller may record digital content attribute information contained in the digital content reproduced at the reproduction part to the tag memory.

When digital contents stored to the tag memory exceed the capacity of the tag memory, the controller may delete a first-stored digital content and store a new digital content to the tag memory.

The reproduction part may include a display part which displays the digital content, and the controller may store a text in an area selected by a user from a text included in the digital content displayed on the display part, to the tag memory.

The reproduction part may include a display part which displays the digital content, and the controller may store information linked to an area selected by a user from the digital content displayed on the display part, to the tag memory.

The tag memory may store a plurality of different digital contents by discriminating using a separator, or may store the plurality of the digital contents to each of a preset number of divided areas of the tag memory, and the tag logic part may transmit the plurality of the digital contents stored to the tag memory to an external RFID reader in sequence at intervals.

The information apparatus may be one of a compact disc player (CDP), a MP3 player (MP3P), a portable multimedia player (PMP), a desktop computer, a notebook computer, a radio, a television, and a mobile phone.

According to the aspect of the present invention, a control method of an information apparatus having an RFID tag includes reproducing a digital content provided from outside, storing all or part of the reproduced digital content by directly accessing to a tag memory, and transmitting the digital content stored to the tag memory to an external RFID reader as an RF signal when the RFID reader approaches into a certain range.

The control method may further include partitioning the digital content into a format including an identifier when a quantity of the digital content exceeds a capacity of the tag memory, and overwriting the partitioned digital contents to the tag memory in sequence.

The digital content may be partitioned into a format including an identifier when a quantity of the digital content exceeds a capacity of one tag memory, and the partitioned digital contents may be written or overwritten to memories of a plurality of RFID tags in parallel.

When digital contents stored to the tag memory exceed the capacity of the tag memory, a first-stored digital content may be deleted and a new digital content may be stored to the tag memory.

The digital content may be displayed on a display part, and storing a text in an area selected by a user from a text included in the digital content displayed on the display part, to the tag memory.

The plurality of different digital contents is stored to the tag memory by discriminating the digital contents using a separator or stored to each of a preset number of divided areas of the tag memory, and the plurality of the digital contents stored to the tag memory is transmitted to an external RFID reader in sequence at intervals.

### Advantageous Effects

According to the present invention, the digital content stored to or reproduced at the information apparatus is easily transferred and stored to the personal device having the RFID reader and then used. Thus, the utilization of the digital content can be drastically enhanced.

Specifically, it is possible to easily transfer, store, and utilize the digital content reproduced at the information apparatus installed in a public space such as subway station or exhibition hall to the personal device.

Furthermore, it is possible to transfer and store the mass digital content to a user's intended personal device through the RFID channel which is the relatively inexpensive communication channel, by more efficiently controlling the capacity-limited memory of the RFID tag.

### BRIEF DESCRIPTION OF THE DRAWINGS

FIG. 1 is a block diagram of an information apparatus with an RFID tag according to one embodiment of the present invention.

FIG. 2 is a block diagram of an information apparatus with an RFID tag according to another embodiment of the present invention.

FIG. 3 is a flowchart outlining operations of the information apparatus of FIG. 2.

FIG. 4 is a diagram showing a format of a digital content stored to a tag memory of the information apparatus according to one embodiment of the present invention.

FIG. 5 is a block diagram of an information apparatus with an RFID tag according to yet another embodiment of the present invention.

FIG. 6 is a flowchart outlining a control method of the information apparatus with the RFID tag according to yet another embodiment of the present invention.

FIG. 7 is a diagram showing a text displayed on a screen, in which a specific area is selected by a user.

### BEST MODE FOR CARRYING OUT THE INVENTION

The embodiments are described below in order to explain the present invention by referring to the figures.

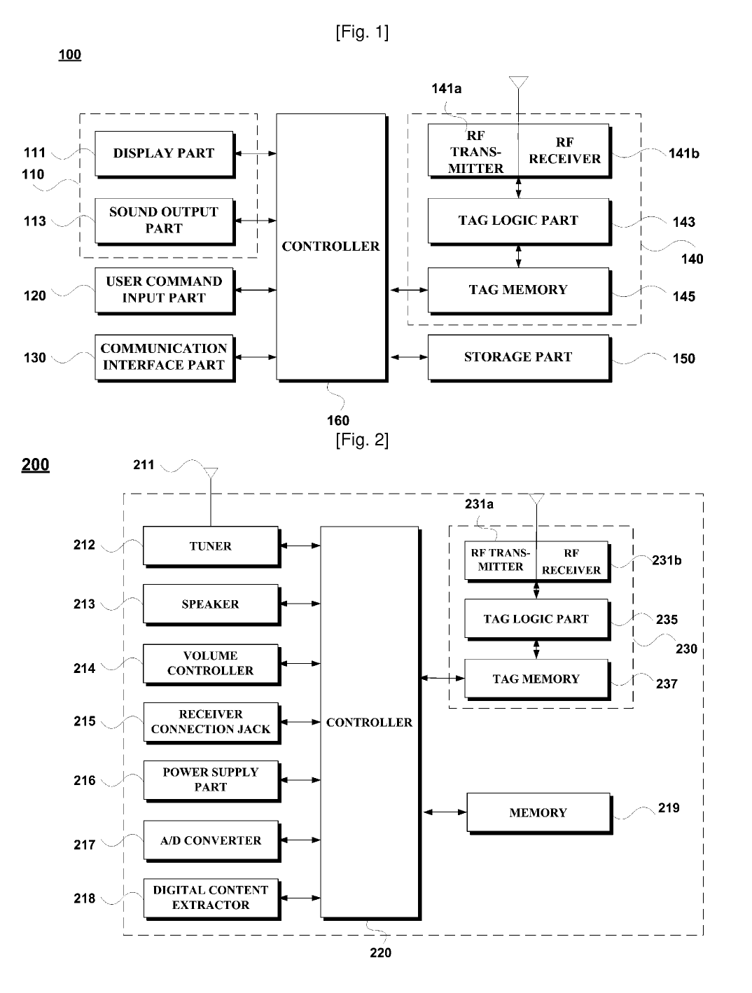

FIG. 1 is a block diagram of an information apparatus with an RFID tag according to one embodiment of the present invention.

Referring to FIG. 1, the information apparatus 100 includes a reproduction part 110, a user command input part 120, a communication interface part 130, an RFID tag part 140, a storage part 150, and a controller 160.

The RFID tag part 140 includes an RF transmitter 141a, an RF receiver 141b, a tag logic part 143, and a tag memory 145.

The RF receiver 141a receives an RF signal from outside and provides the received RF signal to the tag logic part 143. The RF transmitter 141a transmits an RF signal corresponding to data provided from the tag logic part 143 to outside.

The tag logic part 143 controls operations of the RFID tag part 140, processes the RF signal received through the RF receiver 141b, and transmits data stored to the tag memory 145 to outside through the RF transmitter 141a.

The tag memory 145 stores a digital content under the control of the controller 160 and provides the stored digital content to an external RFID reader (not shown) through the RF transmitter 141a.

The communication interface part 130 enables the information apparatus 100 to perform wired or wireless data transmission and reception to and from the outside. The communication interface part 130 can be implemented using a wire/wireless network communication module capable of receiving data over a wire/wireless network, or using a tuner capable of receiving broadcast signals. It is to be understood that the communication interface part 130 can receive the digital content stored to a storage medium of a CD ROM, DVD or USB memory, and so forth through a CD ROM drive, a DVD drive, a USB port, and so forth.

The reproduction part 110 serves to reproduce the digital content under the control of the controller 160. The reproduction part 110 can include a display part 111 and a sound output part 113. The display part 111 displays the digital content under the control of the controller 160. The display part 111 can be implemented using a display means such as LCD panel and PDP panel. The sound output part 113 outputs the sound of the digital content reproduced at the information apparatus 100. The sound output part 113 can be implemented using a speaker.

The user command input part 120 functions to receive a command from a user of the information apparatus 100 and forward the input command to the controller 160. According to embodiments, the user command input part 120 can be implemented using a mouse, a keyboard, a keypad, or a touch screen.

The storage part 150 stores various data. In the embodiment of the present invention, the storage 150 can store digital contents input from the outside and control programs for controlling the information apparatus 100.

The controller 160 is responsible to control overall operations of the information apparatus 100. The controller 160 controls to display the digital content on the display part 111 and enables data reading, writing and deletion by accessing directly to the tag memory 145 without passing through the RF transmitter 141a and the RF receiver 141b. Particularly, the controller 160 of the present invention is able to store or delete all or part of the digital contents to or from the tag memory 145. In the embodiment of the present invention, note that the digital content covers attribute information of the digital content as well (e.g., in case where the digital content is a movie, additional information of the digital content including title, director, starring, release date, etc). According to various embodiments, the controller 160 may store only the digital attribute information to the tag memory 145.

In the embodiment of the present invention, the information apparatus 100 can be implemented by affixing the RFID tag to a personal device such as compact disc player (CDP), MP3 player (MP3P), portable multimedia player (PMP), desktop computer, notebook computer, radio, television, and mobile phone.

It is preferable to store a plurality of different digital contents to the tag memory by discriminating them using separators or using a number of divided regions, and to sequentially transmit the digital contents stored to the tag memory to the external RFID reader at intervals.

### Mode for the Invention

FIG. 2 is a block diagram of an information apparatus with an RFID tag according to another embodiment of the present invention. In FIG. 2, the information apparatus according to another embodiment of the present invention is a radio.

Referring now to FIG. 2, the information apparatus 200 includes an antenna 211 for capturing a radio broadcast signal, a tuner 212 for tuning to a radio channel, a speaker 213 for reproducing the broadcast to the listener, a volume controller 214 for controlling sound, a receiver connection jack 215 for inserting a receiver, a power supply part 216 for supplying power, an analog-to-digital (A/D) converter 217 for converting an analog signal to a digital signal, a digital content extractor 218 for extracting digital information from the radio broadcast signal, a memory 219 for storing the digital content, a controller 220 for controlling the information apparatus 200, and an RFID tag 230. The controller 220 can access directly to a memory 237 of the RFID tag 230 through a bus or a port (not shown). The controller 220 is able to read, write, and delete data of the tag memory 237.

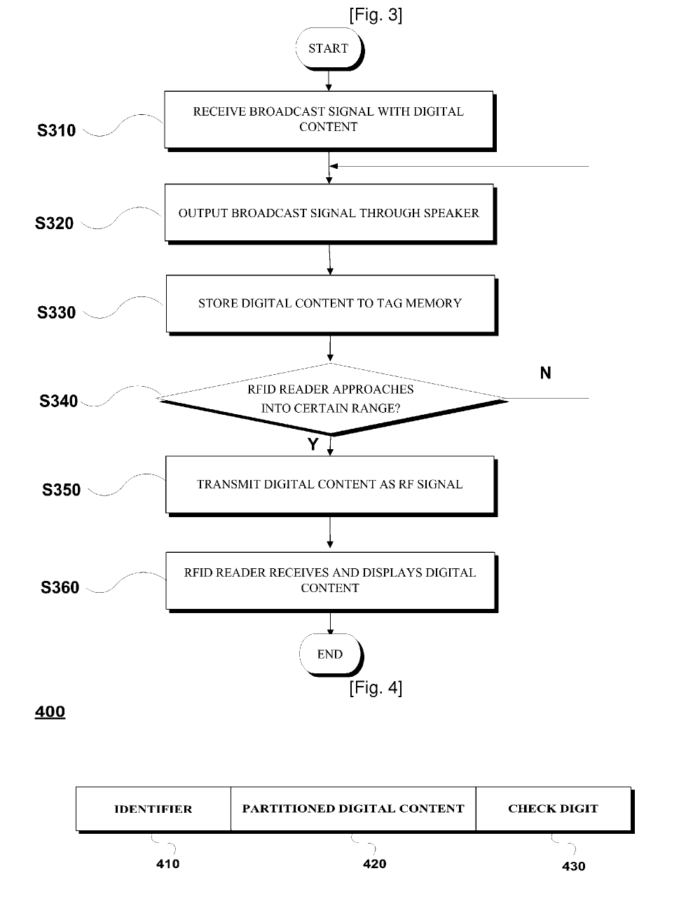

Recently, in the analog broadcasting, the broadcast station is emitting digital contents including additional information of songs such as lyric and personal information of singers. As listening to the radio broadcast, the listener can approach a mobile phone or a personal digital assistant (PDA) having an RFID reader to the radio of the present invention and acquire the lyric of the song from the radio through the screen of the mobile phone or the PDA, which will be further explained in reference to FIG. 3.

FIG. 3 is a flowchart outlining operations of the information apparatus 200 of FIG. 2.

Referring to FIGS. 2 and 3, when the power is supplied to the radio 200 through the power supply part 216 and the broadcast signal of the radio channel tuned by the tuner 212 is received via the antenna 211 (S310), the controller 220 outputs the received broadcast signal through the speaker 213 to thus provide the analog broadcast of the broadcasting station to the listener (S320).

Next, the digital content emitted together with the analog broadcast signal is extracted at the digital content extractor 218 and recorded to the tag memory 237 by the controller 220 (S330).

Afterwards, while listening to the broadcast, when the user approaches the mobile phone or the PDA having the RFID reader to the information apparatus 200 into a certain range (S340-Y), the RFID tag 230 transmits the digital content stored to the tag memory 237 as an RF signal (S350).

Finally, the mobile phone or PDA having the RFID reader displays the digital content received from the RFID tag 237 through a display means (not shown) for the user's perception (S360).

Meanwhile, receiving a new digital content, the controller 220 may delete the old digital content recorded to the tag memory 237 and write the new digital content.

According to various embodiments, different digital contents can be sequentially stored to the tag memory 237. When the memory capacity is exceeded, the oldest digital content can be deleted from the tag memory 237 to record a new digital content to the tag memory 237. In this case, the digital contents may be stored to the tag memory 237 by discriminating them with separators or stored to each of a preset number of divided areas of the tag memory 237. As such, by storing the plurality of the digital contents to the tag memory 237, the user can acquire not only the information as to the song on the air but also the information as to the songs that were broadcast.

When the plurality of digital contents is stored to the tag memory 237, a tag logic part 235 of the RFID tag 230 can transmit the stored digital contents to the RFID reader in sequence at intervals.

In another embodiment of the present invention, it is possible to service the information as to the music on the air (title, singer, lyric, etc) and the broadcast program information to the user together with the broadcasting in the form of digital data. In the radio broadcasting, the user can check and store the music information to remember using a personal device having the RFID reader.

So far, although the radio exemplifies the information apparatus of the present invention, a MP3P is applicable to the present invention. The MP3P is able to store the digitized sound data with the digital content including the information as to the sound data. In the embodiment of the present invention, the MP3P having the RFID tag records the digital content information as to the corresponding sound data to the memory of the RFID tag when reproducing the sound data to deliver the digital content information to the mobile phone or PDA having the RFID reader so that the user can acquire the information as to the reproduced sound data. Likewise, the information apparatus having the RFID tag is applicable to a CD player, a television, a computer and a mobile phone.

In the embodiments of the present invention, the user acquires the digital content using the mobile phone or PDA having the RFID reader, but not limited to these devices. For instance, the user can acquire the digital content stored to the tag memory by mounting the RFID reader to a personal computer and to a digital clock or an eyewear having a monitoring function. That is, every personal device with the RFID reader can be utilized to acquire the digital content stored to the tag memory. Herein, the RFID reader is able to display the digital content received from the RFID tag using its own display means or using a display means of the personal device having the RFID reader.

FIG. 4 is a diagram showing a format of the digital content stored to the tag memory of the information apparatus according to one embodiment of the present invention.

Referring to FIGS. 1 and 4, the quantity of the digital content may exceed the capacity of the memory 145 of the RFID tag part 140. In this case, the digital content is divided and transmitted according to the protocol between the RFID reader and the RFID tag to address the limited capacity of the tag memory 145. The format 400 contains an identifier 410 and a partitioned digital content 420. If necessary, the format 400 further includes a check digit 430. When the digital content exceeds the capacity of the tag memory 145, the controller 160 of the information apparatus 100 partitions the digital content in accordance with the capacity of the tag memory 145, assigns the identifier, and writes or overwrites the partitioned digital contents to the tag memory 145. The RFID reader receives and temporarily stores the identifier and the digital content to a buffer of the RFID reader. The RFID reader repeatedly reads the tag memory 145 in conformity to the prescribed protocol. When the identifier differs, the RFID reader reads and appends the identifier to the buffer. The RFID reader repeats the reading of the tag memory 145 until the identifier informs the end. When the identifier indicates the end, the RFID reader stores and displays the digital content. Note that the RFID reader can first display the pre-received digital content and continuously receive the rest digital contents at the same time while receiving the partitioned digital contents.

In the mean time, the information apparatus may receive information from outside, store the received information to its memory, perform the time delay, and write the information to the RFID tag memory. Since the time delay does relate to the substantial implementation of the information apparatus, its further description shall be omitted.

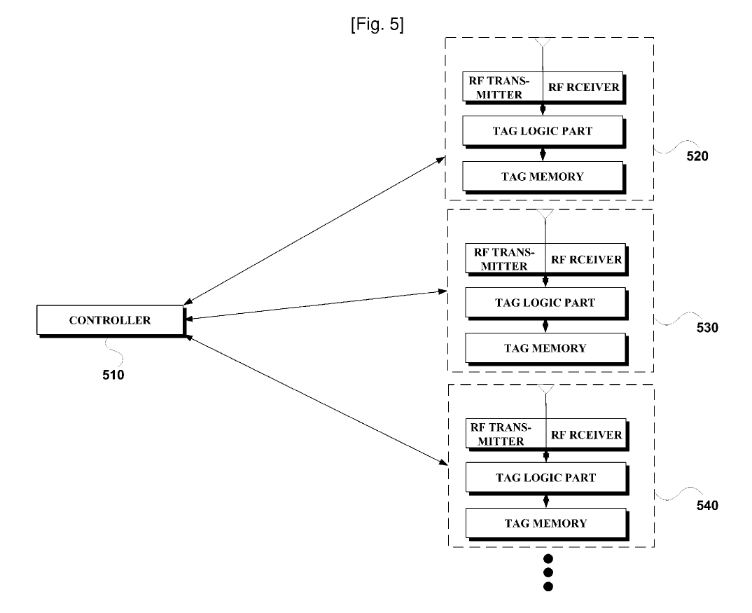

FIG. 5 is a block diagram of an information apparatus with an RFID tag according to yet another embodiment of the present invention.

Referring to FIG. 5, a plurality of RFID tags is attached to the information apparatus 500. In yet another embodiment of the present invention, a controller 510 and RFID tags 520, 530 and 540 are illustrated to ease the understanding. A greater number of RFID tags can be affixed to the information apparatus 500.

In case where the digital content exceeds the capacity of one tag memory, the controller 510 of the information apparatus 500 partitions the digital content in accordance with the capacity of the tag memories 520, 530, and 540, appends identifies as shown in FIG. 4, and writes or overwrites the partitioned digital contents to the tag memory of the RFID tags 520, 530, and 540 in parallel. The RFID reader can receive the digital contents stored to the tag memory of the RFID tags 520, 530, and 540 in parallel, combines the partitioned digital contents, store and display the combined digital content.

The information apparatus of FIG. 5, which the plurality of the RFID tags is affixed to, can be used to not only transmit the mass digital content but also store the different digital contents to the RFID tags 520, 530, and 540 and provide them to the RFID reader in parallel.

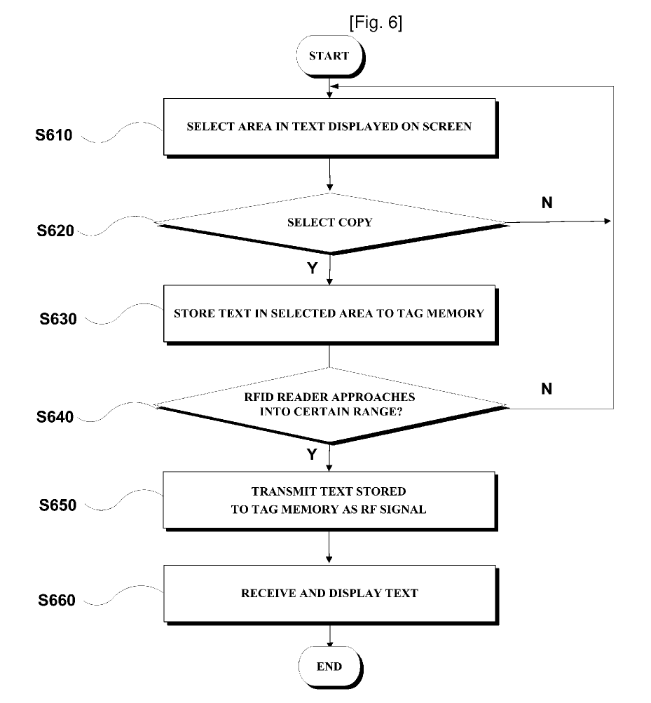

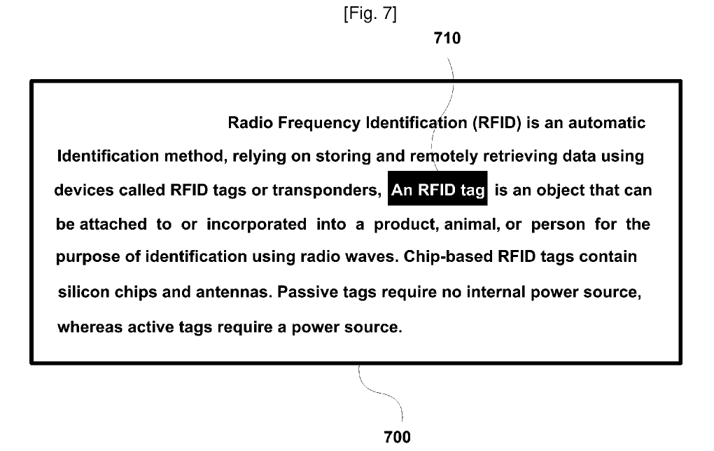

FIG. 6 is a flowchart outlining a control method of the information apparatus with the RFID tag according to yet another embodiment of the present invention. FIG. 7 is a diagram showing a text displayed on a screen, in which a specific area is selected by a user. The embodiment of FIG. 6 is applicable to an information apparatus which enables the user to select a specific area of the text displayed on the screen such as computer, notebook computer, and PDA.

Referring now to FIGS. 1, 6, and 7, after selecting a specific area 710 in the text displayed on a screen 700 as shown in FIG. 7 (S610), when the user selects to copy it (S620), the controller 160 stores the text An RFID tag of the user s selected area to the tag memory 145 (S630).

Next, when the user approaches the RFID reader to the information apparatus 100 (S640-Y), the RFID tag part 140 transmits the text An RFID tag stored to the tag memory 145 to the RFID reader as the RF signal (S650) to store and display it to the device having the RFID reader (S660).

Specifically, by dragging an intended area of the text displayed in the computer screen using a mouse, defining a block, and selecting to copy, the user can transfer and store the corresponding text to a personal device having the RFID reader. By way of example, with a computer having the RFID tag of the present invention and a mobile phone having the RFID reader, the user selects a desired restaurant using the computer over Internet, drags the phone number of the restaurant in the web page showing the search result, selects to copy it, and then stores the phone number to the mobile phone.

Although the text of the user s selected area of the text displayed in the screen is stored to the tag memory in this embodiment of the present invention, modifications are allowed as follows.

When there is information linked to the selected area, the controller 160 can store the linked information to the tag memory 145. For instance, when the user s selected area in the displayed text is a movie title and the information apparatus 100 holds information linked to the movie, such as director, starring, and cinema, the controller 160 can store the linked information to the tag memory 145.

To be sure, the information linked to the user s selected area in the display image may be stored to the tag memory. For instance, in the image displayed on the screen, when the user s selected area is a singer s face and the information apparatus 100 holds the information linked to the singer, such as song title, lyric, and personal web page (mini-homepage, blog, planet, etc) address, the controller 160 may store the linked information to the tag memory 145.

As set forth above, the digital content transferred and stored from the information apparatus to the personal device having the RFID reader may vary. For instance, all or part of the digital contents reproduced at the information apparatus may be transferred to the personal device, and the attribute information relating to the digital content may be transferred. Also, when the digital content is serviced over Internet, uniform resource locator (URL) corresponding to the Internet address of the corresponding digital content may be transferred to the personal device. Therefore, the user can utilize the corresponding digital content through the personal device with the URL acquired from the information apparatus.

Although a few embodiments of the present invention have been shown and described, it would be appreciated by those skilled in the art that changes may be made in this embodiment without departing from the principles and spirit of the invention, the scope of which is defined in the claims and their equivalents.

### INDUSTRIAL APPLICABILITY

The present invention can enhance the utilization of the digital content in the application fields of information communication industry and the digital content industry.

1. An information apparatus having a radio frequency identification (RFID) tag, comprising:
the RFID tag part which comprises an RF receiver receiving an external RF signal, an RF transmitter transmitting an RF signal to outside, a logic part performing controlling and comparison, and a tag memory storing data; and
a controller which stores a digital content provided from outside by directly accessing to the tag memory without passing through the RF receiver and the RF transmitter.

2. The information apparatus as in claim 1, further comprising:
a communication interface part which receives the digital content from outside; and
a reproduction part which reproduces the digital content under control of the controller.

3. The information apparatus as in claim 2, wherein the controller partitions the digital content into a format including an identifier and sequentially overwrites to the tag memory when a quantity of the digital content exceeds a capacity of the tag memory.

4. The information apparatus as in claim 2, wherein the RFID tag part includes a plurality of RFID tags, and
when a quantity of the digital content exceeds a capacity of one tag memory, the controller partitions the digital content into a format including an identifier and writes or overwrites to the memory of the RFID tags, respectively, in parallel.

5. The information apparatus as in claim 2, wherein the controller records digital content attribute information contained in the digital content reproduced at the reproduction part to the tag memory.

6. The information apparatus as in claim 5, wherein, when digital contents stored to the tag memory exceed the capacity of the tag memory, the controller deletes a first-stored digital content and stores a new digital content to the tag memory.

7. The information apparatus as in claim 2, wherein the reproduction part comprises a display part which displays the digital content, and
the controller stores a text in an area selected by a user from a text included in the digital content displayed on the display part, to the tag memory.

8. The information apparatus as in claim 2, wherein the reproduction part comprises a display part which displays the digital content, and
the controller stores information linked to an area selected by a user from the digital content displayed on the display part, to the tag memory.

9. The information apparatus as in claim 2, wherein the tag memory stores a plurality of different digital contents by discriminating using a separator or stored to each of a preset number of divided areas of the tag memory, and
the tag logic part transmits the plurality of the digital contents stored to the tag memory to an external RFID reader in sequence at intervals.

10. The information apparatus as in claim 1, wherein the information apparatus is one of a compact disc player (CDP), a MP3 player (MP3P), a portable multimedia player (PMP), a desktop computer, a notebook computer, a radio, a television, and a mobile phone.

11. A control method of an information apparatus having an RFID tag, the method comprising:
reproducing a digital content provided from outside;
storing all or part of the reproduced digital content by directly accessing to a tag memory; and
transmitting the digital content stored to the tag memory to an external RFID reader as an RF signal when the RFID reader approaches into a certain range.

12. The control method as in claim 11, further comprising:
partitioning the digital content into a format including an identifier when a quantity of the digital content exceeds a capacity of the tag memory; and
overwriting the partitioned digital contents to the tag memory in sequence.

13. The control method as in claim 11, wherein the digital content is partitioned into a format including an identifier when a quantity of the digital content exceeds a capacity of one tag memory; and
the partitioned digital contents are written or overwritten to memories of a plurality of RFID tags in parallel.

14. The control method as in claim 11, wherein digital content attribute information contained in the reproduced digital content is recorded to the tag memory.

15. The control method as in claim 11 wherein, when digital contents stored to the tag memory exceed the capacity of the tag memory, a first-stored digital content is deleted and a new digital content is stored to the tag memory.

16. The control method as in claim 11, the reproducing of the digital content comprises:
displaying the digital content on a display part, and storing a text in an area selected by a user from a text included in the digital content displayed on the display part, to the tag memory.

17. The control method as in claim 11, the reproducing of the digital content comprises:
displaying the digital content on a display part, and storing information linked to an area selected by a user from the digital content displayed on the display part, to the tag memory.

18. The control method as in claim 11, wherein a plurality of different digital contents is stored to the tag memory by discriminating the digital contents using a separator or stored to each of a preset number of divided areas of the tag memory, and the plurality of the digital contents stored to the tag memory is transmitted to an external RFID reader in sequence at intervals.

19. The control method as in claim 11, wherein the information apparatus is one of a CDP, a MP3P, a PMP, a desktop computer, a notebook computer, a radio, a television, and a mobile phone.
